(19) United States
(12) Patent Application Publication
(10) Pub. No.: US 2026/0246934 A1
(43) Pub. Date: Aug. 20, 2026

(54) RATE-DISTORTION OPTIMIZED QUANTIZATION METHOD AND APPARATUS

(71) Applicant: SHANGHAI BILIBILI TECHNOLOGY CO., LTD., Shanghai (CN)

(72) Inventors: Xiaobo LI, Shanghai (CN); Tianxiao YE, Shanghai (CN)

(21) Appl. No.: 18/870,284

(22) PCT Filed: Dec. 30, 2022
(86) PCT No.: PCT/CN2022/143806

§ 371 Date: Nov. 27, 2024

(30) Foreign Application Priority Data
Jun. 1, 2022 (CN) 202210617816.3

(51) Int. Cl. H04N 19/124; H04N 19/136; H04N 19/176

(52) U.S. Cl. CPC H04N 19/124; H04N 19/136; H04N 19/176

(57) ABSTRACT

The application discloses a rate-distortion optimized quantization method, including: determining a plurality of mapping groups in a superblock, wherein each mapping group includes a context and an initial quantization level, the superblock is a coding block unit in a to-be-coded video frame, the superblock includes a plurality of elements, and the context is used to represent correlation information between an element associated with a corresponding mapping group and a plurality of adjacent elements; determining a coded bit quantity difference of each mapping group, wherein the coded bit quantity difference is a difference between a coded bit quantity of the initial quantization level in the corresponding mapping group and a coded bit quantity of the initial quantization level minus one in the corresponding mapping group; and determining a target quantization level of each element in the superblock based on the coded bit quantity difference of each mapping group.

The application is the U.S. National Stage of International Application No. PCT/CN2022/143806, filed on Dec. 30, 2022, which claims priority to Chinese Patent Application No. 202210617816.3, filed on Jun. 1, 2022, and entitled “RATE-DISTORTION OPTIMIZED QUANTIZATION METHOD AND APPARATUS”, which is incorporated herein by reference in its entirety.

### TECHNICAL FIELD

The application relates to the video coding field, and in particular, to a rate-distortion optimized quantization method and apparatus, a computer device, and a computer-readable storage medium.

### BACKGROUND

Currently, all mainstream video coding standards are based on a hybrid video coding framework, and quantization plays an important role and is also a source of a video loss. A rate-distortion optimized quantization (RDOQ) technology is used as an example. The RDOQ technology is applied to video coding standards such as high efficiency video coding (HEVC) and AV1, to improve video coding performance and save a bit rate.

However, the inventor is aware that the existing RDOQ technology has a large amount of calculations, resulting in low efficiency and serious waste of calculation resources.

### BRIEF DESCRIPTION OF DRAWINGS

FIG. 1 is a schematic diagram of an application environment of a rate-distortion optimized quantization method according to an embodiment of the application;

FIG. 2 is a schematic flowchart of a rate-distortion optimized quantization method according to Embodiment 1 of the application;

FIG. 3 is a schematic sub-flowchart of step S204;

FIG. 4 is an another schematic sub-flowchart of step S204;

FIG. 5 is an another schematic sub-flowchart of step S204;

FIG. 6 schematically shows steps of determining a reference threshold;

FIG. 7 is a schematic block diagram of a rate-distortion optimized quantization apparatus according to Embodiment 2 of the application; and

FIG. 8 is a schematic diagram of a hardware architecture of a computer device suitable for implementing a rate-distortion optimized quantization method according to Embodiment 3 of the application.

### DESCRIPTION OF EMBODIMENTS

To make the objectives, technical solutions, and advantages of the application clearer and more comprehensible, the following further describes the application in detail with reference to the accompanying drawings and the embodiments. It should be understood that the specific embodiments described herein are merely used to explain the application but are not intended to limit the application. All other embodiments obtained by a person of ordinary skill in the art based on embodiments of the application without creative efforts shall fall within the protection scope of the application.

It should be noted that the descriptions such as “first” and “second” in the embodiments of the application are merely used for description, and shall not be understood as an indication or implication of relative importance or an implicit indication of a quantity of indicated technical features. Therefore, a feature defined with “first” or “second” may explicitly or implicitly include at least one feature. In addition, technical solutions in the embodiments may be combined with each other, provided that a person of ordinary skill in the art can implement the combination. When the combination of the technical solutions is contradictory or cannot be implemented, it should be considered that the combination of the technical solutions does not exist and does not fall within the protection scope of the application.

In the descriptions of the application, it should be understood that numerical symbols before steps do not indicate a sequence of performing the steps, but are merely used to facilitate description of the application and differentiation of each step, and therefore cannot be construed as a limitation on the application.

The following provides an explanation of the terms in the application:

AV1 is an open-source and royalty-free video codec developed by a non-profit industry alliance “Alliance for Open Media (AOMedia)”. Based on a use situation, AV1 can achieve higher compression efficiency than VP9 and H.264.

A context indicates a relationship with adjacent elements, and is used to provide association information of the adjacent elements.

Quantization is a process of mapping continuous values (or a large quantity of possible discrete values) of a signal onto a limited quantity of discrete amplitude values, and is many-to-one mapping. In a video coding process, after a discrete cosine transform (DCT) is performed on a residual signal, a transform coefficient usually has a relatively large range. Therefore, quantization of the transform coefficient can effectively reduce signal value space, thereby obtaining a better bit rate. However, due to a many-to-one mapping property, a data loss is inevitably introduced in a quantization process. Quantization is an important source of video distortion in video coding.

Rate-distortion optimized quantization (RDOQ) is a coefficient optimization algorithm. Specifically, in video coding, distortion and a bit rate are factors that affect coding performance. The distortion reflects video quality (quantization is an important source of distortion), and the bit rate reflects a compression rate. The bit rate is usually increased if the distortion is reduced; and the distortion is usually increased if the bit rate is reduced. Therefore, the distortion and the bit rate need to be balanced in video coding. In view of this, a rate-distortion optimized quantization (RDOQ) technology is introduced, to balance the distortion and the bit rate. In the technology, a quantization process and a rate-distortion optimization (RDO) criterion are combined. For a transform coefficient, a plurality of optional quantization values are given, and an optimal quantization value (quantization level) is selected based on the RDO criterion.

To help a person skilled in the art understand the technical solutions provided in the embodiments of the application, the following describes related technologies.

An AV1 coding procedure includes the following procedures: division into units, intra-frame prediction, inter-frame prediction, transform, quantization, and the like.

Division into units: An image is divided into a plurality of units, to decode the image in units. For example, the image may be divided into 128×128 units, namely, largest coding units (superblocks). The superblock may be further divided into four equal parts (SPLIT) or two equal parts (HORZ or VERT). Subunits of the four equal parts may be further divided.

Intra-frame prediction: Intra-frame spatial redundancy is removed, to obtain a residual unit whose pixel value is less than that of a coding unit.

Inter-frame prediction: Inter-frame time redundancy is removed, to obtain a residual unit whose pixel value is less than that of the coding unit.

Transform: For example, low-frequency information and high-frequency information are separated through a discrete cosine transform (DCT), to transform the residual unit into a “transform unit (TU)”. It should be noted that another transform manner may also be used.

Quantization: A transform coefficient in the TU is quantized based on a quantization step, to obtain a quantization level. In this way, an amount of data used to represent the coefficient is reduced.

RDOQ: The quantization level obtained through quantization is slightly adjusted without affecting video quality, to save a bit rate.

An RDOQ procedure used for AV1 coding is as follows:
Step 1: Scan transform coefficients in a TU in a scanning sequence (Z scanning, horizontal scanning, or vertical scanning), until all elements in the TU are processed. It is assumed that a current scanning position is ScanPos, and a bit quantity of a current element is Rate=0.
Step 2: Obtain a transform coefficient of the current scanning position scanPos, to obtain an initial quantization level level (absolute value) and a sign flag sign.
Step 3: If level is 0, the current element does not need to be adjusted. A next element continues to be processed, provided that level=0.
Step 4: If level≤2, obtain a context required for coding a BR, where the context is denoted as ctx_br; obtain, based on ctx_br and level, a bit quantity brrate required for coding the BR; and execute Rate+=brrate+512, where 512 is a bit quantity required for coding the sign.
Step 5: If 3≤level≤14, in addition to the context required for coding the BR, a context for coding an LR further needs to be obtained, and is denoted as ctx_lr; a bit quantity lrrate required for coding the LR is obtained based on ctx_lr and level; and Rate+=lrrate is executed.
Step 6: If level≥15, in addition to the context required for coding the BR and the LR, a bit quantity hrrate for coding an HR further needs to be obtained based on level, and Rate+=hrrate is executed.
Step 7: Obtain distortion Dist brought by coding the current element to level.

Assuming that a transform coefficient corresponding to the current element is tqc, a dequantization coefficient of level is dqc. In this case, Dist=(tqc−dqc)*(tqc−dqc).
Step 8: Calculate a rate-distortion cost RD when the current element is coded to level, where RD=λ*Rate+Dist.

Herein, λ is a Lagrange parameter in rate-distortion optimization, and a value of X has a corresponding function relationship with a quantization parameter (QP).
Step 9: Repeatedly perform step 2 to step 8. Assuming that an element that needs to be coded currently is level-1, a new bit rate Rate_{low}, new distortion Dist_{low}, and a new rate-distortion cost RD_{low} are obtained.
Step 10: Compare a value of RD and a value of RD_{low}. If RD_{low}≤RD, it indicates that it is more proper to code an absolute value of the current element to level-1.

As described above, the following problems exist in a process of determining level of each element, resulting in a large calculation amount of RDOQ.

1. In an RDOQ algorithm, level of each element is dynamically adjusted. However, a context needs to be calculated based on latest level of an adjacent element in a process of calculating brrate and lrrate. Consequently, a calculation amount of RDOQ is very large.

2. In the RDOQ algorithm, bit rates in two cases of level and level-1 need to be calculated in a process of adjusting level of each element. In other words, Rate needs to be calculated for two times for each position scanPos, and consequently, a calculation amount is doubled.

In view of the foregoing problems, the application aims to provide a rate-distortion optimized quantization solution for AV1, to resolve the foregoing problems. Specifically, 1. For all elements of a superblock, contexts are collectively calculated through instruction set optimization, and subsequently, no context is calculated even if level is updated. Contexts of a plurality of elements may be calculated through instruction set optimization. In this way, time is saved. 2. Rate and Rate_{low} are not calculated independently. Instead, a coded bit quantity difference ΔRate needs to be obtained based on only the context and level, and a value relationship between the bit quantity difference ΔRate and −dequant/λ·((2level−1)·dequant−2tqc) is determined through comparison, to determine whether to adjust a quantization level. For explanations of the parameters, refer to the following descriptions.

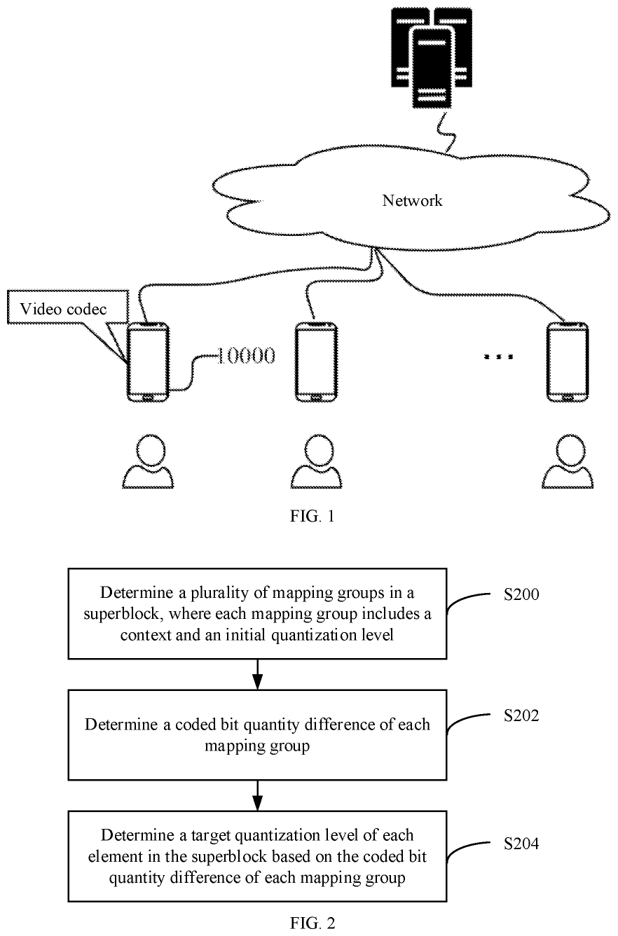

The following provides an example application environment of the application. For example, the application may be applied to a computer device 10000 shown in FIG. 1.

The computer device 10000 may be configured to access content (for example, a video) and a service of a server.

The computer device 10000 may include an electronic device that carries or is connected to a display panel, for example, a mobile device, a tablet device, a laptop computer, a workstation, a virtual reality device, a game device, a digital streaming device, a vehicle user terminal, a smart television, or a set-top box, or may include a virtualized computing instance. The virtualized computing instance may include a simulation of a virtual machine such as a computer system, an operating system, or a server.

The computer device 10000 may be associated with one or more users. A single user may also access the server by using one or more electronic devices in the computer device 10000. The computer device 10000 may travel to various positions and use different networks to access the server. The computer device 10000 may include a plurality of client programs such as a video codec, configured to provide a coding service, and a decoding service. The video codec may perform coding and compression on a video or an image, to help transmit or store the video or the image.

The following provides several embodiments in the foregoing example application environment, to describe a rate-distortion optimized quantization solution.

### Embodiment 1

It should be noted that the embodiment may be executed by a computer device 10000.

FIG. 2 is a schematic flowchart of a rate-distortion optimized quantization method according to Embodiment 1 of the application.

As shown in FIG. 2, the rate-distortion optimized quantization method may include steps S200 to S204.

Step S200: Determine a plurality of mapping groups in a superblock, wherein each mapping group includes a context and an initial quantization level, the superblock is a coding block unit in a to-be-coded video frame, the superblock includes a plurality of elements, and the context is used to represent correlation information between an element associated with a corresponding mapping group and a plurality of adjacent elements.

The superblock is a coding block unit defined for AV1 coding, and a size of the superblock may be 128×128. A to-be-coded video frame may include a plurality of superblocks. A superblock may be divided into a plurality of transform units (TUs). Each TU includes a plurality of elements, and each element corresponds to one transform coefficient. For example, if a size of the TU is 4×4, there are correspondingly 4×4 elements, namely, a maximum of 4×4 transform coefficients.

In an example application, a plurality of superblocks are obtained through division based on the to-be-coded video frame, and each superblock is associated with a corresponding area in the to-be-coded video frame. After division into units, intra-frame/inter-frame prediction, and transform are performed on the to-be-coded video frame, a transform coefficient of each element in the superblock is obtained. Then, the transform coefficient is quantized, to transform the transform coefficient into the initial quantization level.

First, the initial quantization level of the element may be calculated in the following manner (an element A is used as an example):

level=floor(c/Qstep+f). Herein, level represents an initial quantization level of the element A, c represents a transform coefficient of the element A, Qstep represents a quantization step, floor is a rounding down function, and f controls a rounding relationship. It should be noted that the foregoing calculation manner is merely an example. The initial quantization level may alternatively be obtained in another calculation manner.

Second, a context of the element may be obtained in the following manner (the element A is still used as an example):

Because the element A is associated with a plurality of adjacent elements of the element A, a context may be constructed in the TU based on quantization levels of several previously processed elements. For example, specific elements whose sum of quantization levels is used as the context of the element A may be determined based on a scanning sequence (Z scanning, horizontal scanning, or vertical scanning).

It should be noted that different initial quantization levels have different coding manners and different contexts. For specific calculation of the context, refer to the technical specification of AV1. For example, if level≤2, a context (a sum of quantization levels of five adjacent elements) required for coding a base range (BR) is determined. If 3≤level≤14, a context (a sum of quantization levels of three adjacent elements) required for coding a low range (LR) is determined. If level≥15, a context required for coding a high range (HR) is determined.

The foregoing describes how to obtain the context and the initial quantization level of the element. It should be noted that, the transform coefficient of the element is transformed into the initial quantization level of the element, to implement compression of the to-be-coded video frame to some extent. However, in the embodiment, after the initial quantization level of each element is obtained, the initial quantization level of the element is slightly adjusted through RDOQ without affecting video quality, to further save a bit rate.

Step S202: Determine a coded bit quantity difference of each mapping group, wherein the coded bit quantity difference is a difference between a coded bit quantity of the initial quantization level in the corresponding mapping group and a coded bit quantity of the initial quantization level minus one in the corresponding mapping group.

RDOQ achieves a balance between distortion and the bit rate, which is embodied in whether to slightly adjust the initial quantization level in the embodiment.

The slight adjustment is choosing between “initial quantization level” of an element and “initial quantization level minus one” of the element. If a rate-distortion cost that needs to be paid to use “initial quantization level minus one” to replace “initial quantization level” is relatively large, replacement is not performed. On the contrary, if the rate-distortion cost is relatively small, replacement is performed.

As described in step S202, in the embodiment, a basis for determining whether to perform slight adjustment is the coded bit quantity difference.

To obtain the accurate coded bit quantity difference, the coded bit quantity of the initial quantization level in the corresponding mapping group is obtained based on the context and the initial quantization level in the corresponding mapping group, and the coded bit quantity of the initial quantization level minus one in the corresponding mapping group is obtained based on the context and the initial quantization level minus one in the corresponding mapping group.

The following provides an example of the coded bit quantity difference:

First, the coded bit quantity may be calculated based on the context and the initial quantization level and a context-based coding algorithm, to obtain a lookup table including a plurality of groups of “context, quantization level, and coded bit quantity”.

Next, a mapping group X is used as an example, and a calculation process of a coded bit quantity difference ΔRate corresponding to the mapping group X is as follows:

(1) A corresponding coded bit quantity (Rate) is calculated based on a context and an initial quantization level (level) of the mapping group X.

\textcircled{1} If level≤2, the context required for coding the BR is obtained, and a coded bit quantity brrate is obtained from the lookup table based on the context and level. Rate+=brrate+512 is executed. 512 is a coded bit quantity required by a sign. \textcircled{2} If 3≤level≤14, the context required for coding the LR is obtained, and a coded bit quantity lrrate is obtained from the lookup table based on the context and level. Rate+=lrrate is executed. \textcircled{3} If level≥15, the context required for coding the HR is obtained, and a coded bit quantity hrrate is obtained based on the context and level. Rate+=hrrate is executed.

(2) A coded bit quantity (Rate_{low}) of the initial quantization level minus one (level-1) is calculated. For a calculation process, refer to the foregoing descriptions.

(3) Rate_{low} corresponding to “initial quantization level minus one” is subtracted from Rate corresponding to “initial quantization level”, to obtain ΔRate.

Based on the foregoing example procedure, the coded bit quantity difference ΔRate of each mapping group may be obtained. Because the coded bit quantity difference ΔRate of each mapping group is calculated in advance, and Rate corresponding to “initial quantization level” and Rate_{low} corresponding to “initial quantization level minus one” do not need to be calculated element by element, calculation resources are saved.

In an optional embodiment, the method further includes:
storing a mapping relationship between each mapping group and the corresponding coded bit quantity difference in a bit quantity difference array, where the bit quantity difference array includes a first bit quantity difference array and a second bit quantity difference array.

The first bit quantity difference array corresponds to an initial quantization level lower than a first preset value; and
the second bit quantity difference array corresponds to an initial quantization level between a second preset value and a third preset value.

“Lower than the first preset value” is “≤2”.

“Between the second preset value and the third preset value” is “between 3 (including an endpoint) and 14 (including an endpoint)”.

In the foregoing embodiment, the bit quantity difference array is set, to provide a query service for subsequent quantization level adjustment, and improve efficiency.

Step S204: Determine a target quantization level of each element in the superblock based on the coded bit quantity difference of each mapping group.

The element A is used as an example. If the rate-distortion cost that needs to be paid to use “initial quantization level minus one” to replace “initial quantization level” is relatively large, “initial quantization level” of the element A is used as a target quantization cost. On the contrary, if the rate-distortion cost is relatively small, “initial quantization level minus one” of the element A is used as a target quantization cost.

According to the rate-distortion optimized quantization method provided in the embodiment of the application, a mapping group “initial quantization level, context, and coded bit quantity difference” in the superblock is obtained in advance. When a specific element is determined, a coded bit quantity Rate of an initial quantization level of the element and a coded bit quantity Rate_{low} corresponding to the initial quantization level minus one of the element do not need to be calculated one by one. Only a coded bit quantity difference ΔRate needs to be obtained based on a context and the initial quantization level of the element, and whether the quantization level of the element is to be adjusted is determined based on the coded bit quantity difference ΔRate, thereby reducing a calculation amount of RDOQ, improving coding efficiency, and avoiding a waste of calculation resources.

In an optional embodiment, the superblock corresponds to a plurality of transform units (TUs).

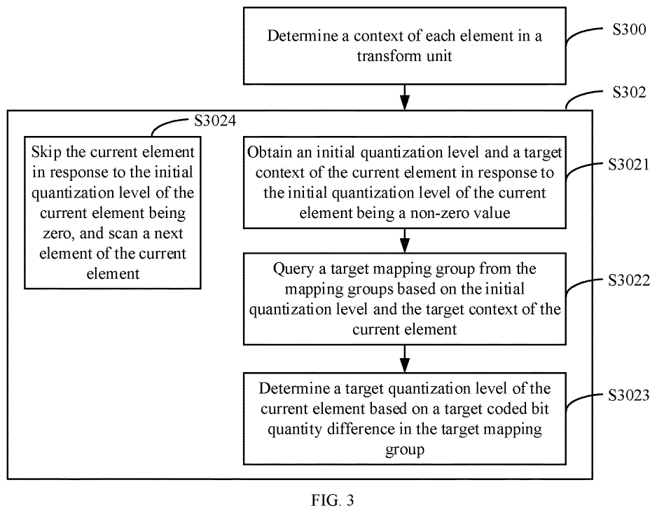

As shown in FIG. 3, step S204 may be implemented by using the following steps: Step S300: Determine a context of each element in the transform unit. Step S302: Scan the transform unit in a preset sequence (Z scanning, horizontal scanning, or vertical scanning), and perform operations in steps S3021 to S3024 when a current element in the transform unit is scanned: Step S3021: Obtain an initial quantization level and a target context of the current element in response to the initial quantization level of the current element being a non-zero value, wherein the current element is an element in the transform unit. Step S3022: Query a target mapping group from the mapping group based on the initial quantization level and the target context of the current element. Step S3023: Determine a target quantization level of the current element based on a target coded bit quantity difference in the target mapping group. Step S3024: Skip the current element in response to the initial quantization level of the current element being zero, and scan a next element of the current element. The next element is used as the current element, and steps S3021 to S3024 are repeatedly performed. Compared with a case in which a context needs to be independently calculated in real time each time an element is scanned, in the embodiment in which contexts may be collectively calculated in advance through instruction set optimization, and subsequently, no context is calculated even if a quantization level of an adjacent element is updated. Because contexts of a plurality of elements are calculated through instruction set optimization, time is saved. In addition, in the embodiment, when the current element is scanned, the context may be obtained instantly, and the target coded bit quantity difference is quickly obtained, to determine, based on the target coded bit quantity difference, whether to adjust the quantization level.

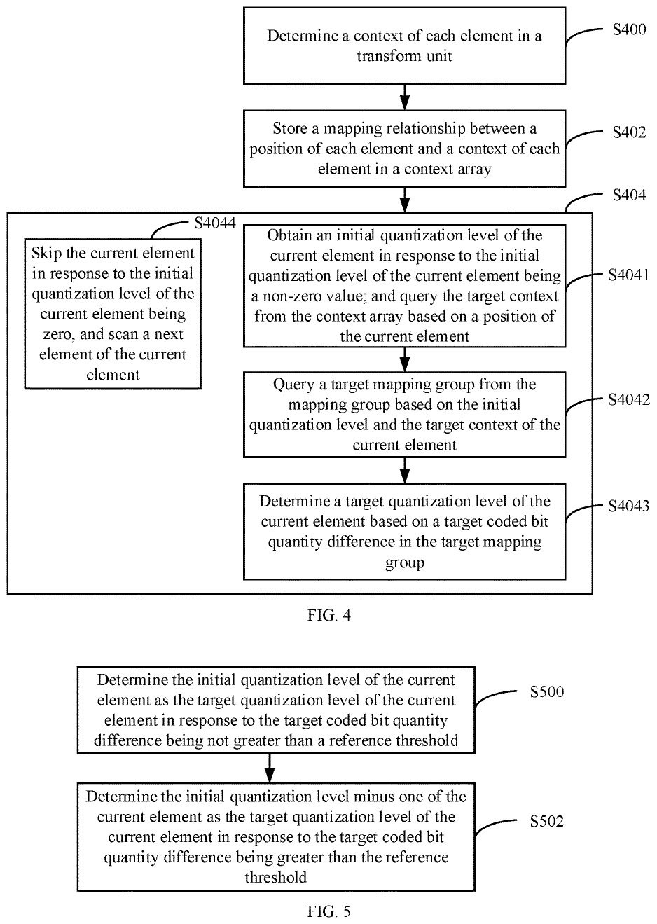

In another optional embodiment, as shown in FIG. 4, step S204 may be implemented by using the following steps: Step S400: Determine a context of each element in the transform unit. Step S402: Store a mapping relationship between a position of each element and a context of each element in a context array. Step S404: Scan the transform unit in a preset sequence, and perform the following operations when a current element in the transform unit is scanned: Step S4041: Obtain an initial quantization level of the current element in response to the initial quantization level of the current element being a non-zero value; and query the target context from the context array based on a position of the current element. Step S4042: Query a target mapping group from the mapping group based on the initial quantization level and the target context of the current element. Step S4043: Determine a target quantization level of the current element based on a target coded bit quantity difference in the target mapping group. Step S4044: Skip the current element in response to the initial quantization level of the current element being zero, and scan a next element of the current element. The next element is used as the current element, and steps S4041 to S4044 are repeatedly performed. Compared with a case in which a context needs to be independently calculated in real time each time an element is scanned, in the embodiment in which contexts may be collectively calculated in advance through instruction set optimization, and subsequently, no context is calculated even if a quantization level of an adjacent element is updated. Because contexts of a plurality of elements are calculated through instruction set optimization, time is saved. In addition, in the embodiment, when the current element is scanned, a previously specified context array may be queried, to quickly obtain a context of the current element through query, and quickly obtain the target coded bit quantity difference through query, so as to determine, based on the target coded bit quantity difference, whether to adjust the quantization level.

For ease of understanding, an example application is provided below.

N×M elements are distributed in one TU, and N and M are natural numbers.

\textcircled{1} Contexts of all the elements (N×M elements) in the TU are determined, and a position of each element and a relationship between the contexts are stored in the context array.

When the TU is scanned and the current element (for example, the element A) is scanned: \textcircled{2} A transform coefficient qcoeff and an initial quantization level level (absolute value) of the element A are obtained.

\textcircled{3} Whether level of the element A is 0 is determined.

\textcircled{4} If level of the element A is 0, the quantization level of the element A does not need to be adjusted, and a next element continues to be processed.

\textcircled{5} If level of the element A is not 0, whether to adjust the quantization level of the element A is further determined. Because the coded bit quantity difference of each mapping group (context-initial quantization level) is determined in advance, the coded bit quantity difference of the element A may be quickly located based on level of the element A and the context of the element A, and further, whether to adjust the quantization level is determined based on the coded bit quantity difference of the element A.

In an optional embodiment, as shown in FIG. 5, step S204 of “Determine a target quantization level of each element in the superblock based on the coded bit quantity difference of each mapping group” may include: Step S500: Determine the initial quantization level of the current element as the target quantization level of the current element in response to the target coded bit quantity difference being not greater than a reference threshold. Step S502: Determine the initial quantization level minus one of the current element as the target quantization level of the current element in response to the target coded bit quantity difference being greater than the reference threshold. Rate and Rate_{low} do not need to be independently calculated for each element; instead, the coded bit quantity difference ΔRate (for example, the target coded bit quantity difference) needs to be quickly obtained based on the context and level, and whether to adjust the quantization level may be determined based on a comparison between the target coded bit quantity difference and the reference threshold, thereby effectively reducing a calculation amount of RDOQ, and saving resources.

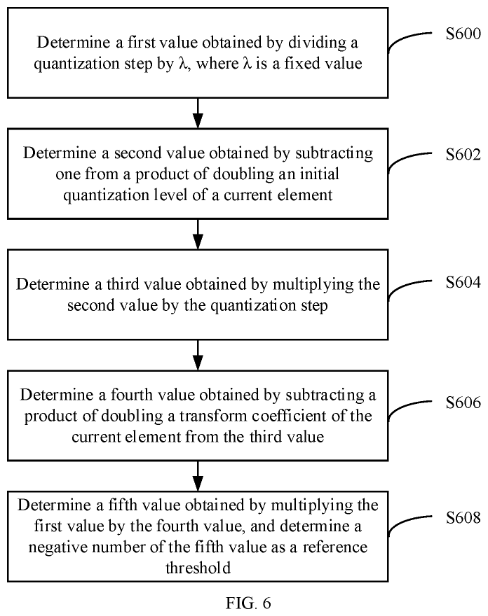

In an optional embodiment, to save calculation resources and ensure accuracy of determining whether to adjust the quantization level, as shown in FIG. 6, the method includes steps of determining the reference threshold: Step S600: Determine a first value obtained by dividing a quantization step by λ, where λ is a fixed value. Step S602: Determine a second value obtained by subtracting one from a product of doubling the initial quantization level of the current element. Step S604: Determine a third value obtained by multiplying the second value by the quantization step. Step S606: Determine a fourth value obtained by subtracting a product of doubling a transform coefficient of the current element from the third value. Step S608: Determine a fifth value obtained by multiplying the first value by the fourth value, and determine a negative number of the fifth value as the reference threshold.

That is, the reference threshold is −dequant/λ·(((2level)−1)·dequant−2tqc). Herein, dequant is the quantization step, λ is a Lagrange parameter, · is multiplication, level is the initial quantization level, and tqc is a transform coefficient of the current element.

If the target coded bit quantity difference is greater than −dequant/λ·(((2level)−1)·dequant−2tqc), the target quantization level is the initial quantization level minus one of the current element. Otherwise, the target quantization level is the initial quantization level of the current element.

The following describes a derivation process of the foregoing formula:

$$R D = λ \cdot Rate + Dist$$

$$R {D}_{low} = λ \cdot {Rate}_{low} + {Dist}_{low}$$

$$R {D}_{low} < R D$$

$$λ \cdot {Rate}_{low} + {Dist}_{low} < λ \cdot Rate + Dist$$

$$λ \cdot ( Rate - {Rate}_{low} ) > {Dist}_{low} - Dist$$

$$λ \cdot Δ Rate > {( tqc - {dq}_{low} )}^{2} - {( tqc - dq )}^{2}$$

$$λ \cdot Δ Rate > ( {dq}_{low} - dq ) ( {dq}_{low} + dq - 2 tqc )$$

$$∵ dq = level \cdot dequant , {dq}_{low} = ( level - 1 ) \cdot dequant$$

$$∴ λ \cdot Δ Rate > - dequant \cdot ( ( 2 level - 1 ) \cdot dequant - 2 tqc )$$

$$Δ Rate > \frac{- d equant}{λ} \cdot ( ( 2 level - 1 ) \cdot dequant - 2 tqc )$$

RD is a rate-distortion cost corresponding to the initial quantization level of the current element;
RD_{low} is a rate-distortion cost corresponding to the initial quantization level minus one of the current element;
Rate is a coded bit quantity corresponding to the initial quantization level of the current element;
Rate_{low} is a coded bit quantity corresponding to the initial quantization level minus one of the current element;
λ is the Lagrange parameter;
Dist is distortion corresponding to the initial quantization level of the current element;
Dist_{low} is distortion corresponding to the initial quantization level minus one of the current element;
tqc is the transform coefficient of the current element;
dq is a dequantization coefficient corresponding to the initial quantization level of the current element;
dq_{low} is a dequantization coefficient corresponding to the initial quantization level minus one of the current element;
level is the initial quantization level of the current element;
dequant is the quantization step;
ΔRate is the bit quantity difference;
· is a multiplication sign;
∴ denotes “because”; and
∵ denotes “therefore”.

The foregoing provides adjustment details and principles of an RDOQ level. Experiments show that, overall coding time can be reduced by 20% when the bit rate is lost by 0.3%, to greatly reduce time overheads of video on-demand during livestreaming.

### Embodiment 2

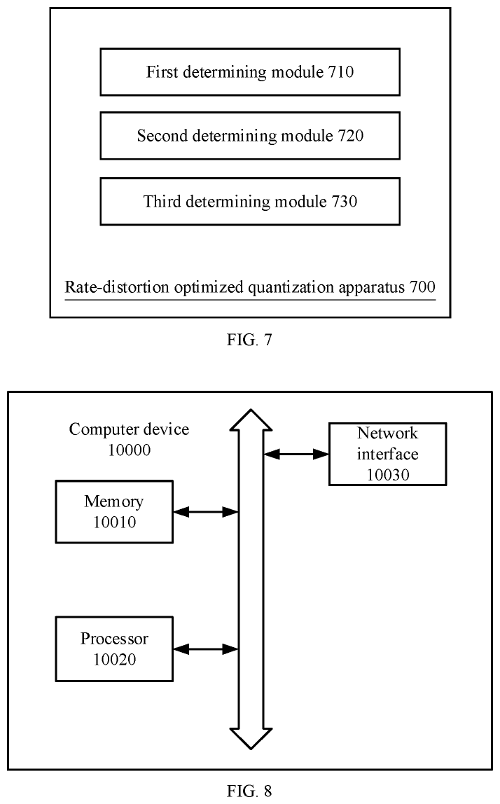

FIG. 7 is a schematic block diagram of a rate-distortion optimized quantization apparatus according to Embodiment 2 of the application. The rate-distortion optimized quantization apparatus may be divided into one or more program module. The one or more program module are stored in a storage medium and executed by one or more processors, to complete the embodiments of the application. The program module in the embodiment of the application is a series of computer-readable instruction segments that can complete a specific function. The following specifically describes a function of each program module in the embodiment. As shown in FIG. 7, the rate-distortion optimized quantization apparatus 700 may include a first determining module 710, a second determining module 720, and a third determining module 730.

The first determining module 710 is configured to determine a plurality of mapping groups in a superblock. Each mapping group includes a context and an initial quantization level, the superblock is a coding block unit in a to-be-coded video frame, the superblock includes a plurality of elements, and the context is used to represent correlation information between an element associated with a corresponding mapping group and a plurality of adjacent elements.

The second determining module 720 is configured to determine a coded bit quantity difference of each mapping group. The coded bit quantity difference is a difference between a coded bit quantity of the initial quantization level in the corresponding mapping group and a coded bit quantity of the initial quantization level minus one in the corresponding mapping group.

The third determining module 730 is configured to determine a target quantization level of each element in the superblock based on the coded bit quantity difference of each mapping group.

In an optional embodiment, the rate-distortion optimized quantization apparatus 700 further includes: a first storage module (not shown), configured to:
store a mapping relationship between each mapping group and the corresponding coded bit quantity difference in a bit quantity difference array, wherein the bit quantity difference array includes a first bit quantity difference array and a second bit quantity difference array.

The first bit quantity difference array corresponds to an initial quantization level lower than a first preset value; and
the second bit quantity difference array corresponds to an initial quantization level between a second preset value and a third preset value.

In an optional embodiment, the superblock corresponds to a plurality of transform units; and
the third determining module 730 is further configured to:
determine a context of each element in a transform unit; and
scan the transform unit in a preset sequence, and perform the following operations when a current element in the transform unit is scanned:
obtaining an initial quantization level and a target context of the current element in response to that the initial quantization level of the current element being a non-zero value, where the current element is an element in the transform unit;
querying a target mapping group from the mapping group based on the initial quantization level and the target context of the current element; and
determining a target quantization level of the current element based on a target coded bit quantity difference in the target mapping group.

In an optional embodiment, the rate-distortion optimized quantization apparatus 700 further includes: a second storage module (not shown), configured to:
store a mapping relationship between a position of each element and a context of each element in a context array; and
the third determining module 730 is further configured to query the target context from the context array based on a position of the current element.

In an optional embodiment, the third determining module 730 is further configured to:
determine the initial quantization level of the current element as the target quantization level of the current element in response to the target coded bit quantity difference being not greater than a reference threshold; and
determine the initial quantization level minus one of the current element as the target quantization level of the current element in response to the target coded bit quantity difference being greater than the reference threshold.

In an optional embodiment, the rate-distortion optimized quantization apparatus 700 further includes: a fourth determining module (not shown), configured to:
determine a first value obtained by dividing a quantization step by k, where X is a fixed value;
determine a second value obtained by subtracting one from a product of doubling the initial quantization level of the current element;
determine a third value obtained by multiplying the second value by the quantization step;
determine a fourth value obtained by subtracting a product of doubling a transform coefficient of the current element from the third value; and
determine a fifth value obtained by multiplying the first value by the fourth value, and
determine a negative number of the fifth value as the reference threshold.

In an optional embodiment, the third determining module 730 is further configured to:
skip the current element in response to the initial quantization level of the current element being zero, and scan a next element of the current element.

In an optional embodiment, the coded bit quantity of the initial quantization level in the corresponding mapping group is obtained based on the context and the initial quantization level in the corresponding mapping group; and the coded bit quantity of the initial quantization level minus one in the corresponding mapping group is obtained based on the context and the initial quantization level minus one in the corresponding mapping group.

### Embodiment 3

FIG. 8 is a schematic diagram of a hardware architecture of a computer device 10000 suitable for implementing a rate-distortion optimized quantization method according to Embodiment 3 of the application. The computer device 10000 is a device that can automatically calculate a value and/or process information based on an instruction that is set or stored in advance. For example, the computer device 10000 may be a smartphone, a tablet computer, a PC, or a virtual reality device. As shown in FIG. 8, the computer device 10000 includes but is not limited to a memory 10010, a processor 10020, and a network interface 10030 that can be communicatively connected to each other through a system bus.

The memory 10010 includes at least one type of computer-readable storage medium. The readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the memory 10010 may be an internal storage means of the computer device 10000, for example, a hard disk or an internal memory of the computer device 10000. In some other embodiments, the memory 10010 may be an external storage device of the computer device 10000, for example, a removable hard disk, a smart media card (SMC), a secure digital (SD) card, or a flash card that is disposed on the computer device 10000. Certainly, the memory 10010 may alternatively include both an internal storage means of the computer device 10000 and an external storage device of the computer device 10000. In the embodiment, the memory 10010 is usually configured to store an operating system and various types of application software that are installed on the computer device 10000, for example, program code of the rate-distortion optimized quantization method. In addition, the memory 10010 may be further configured to temporarily store various types of data that have been output or are to be output.

The processor 10020 may be a central processing unit (CPU), a controller, a microcontroller, a microprocessor, or another data processing chip in some embodiments. The processor 10020 is usually configured to control an overall operation of the computer device 10000, for example, perform control and processing related to data exchange or communication performed by the computer device 10000. In the embodiment, the processor 10020 is configured to run program code stored in the memory 10010 or process data.

The network interface 10030 may include a wireless network interface or a wired network interface, and the network interface 10030 is usually configured to establish a communication link between the computer device 10000 and another computer device. For example, the network interface 10030 is configured to: connect the computer device 10000 and an external terminal through a network, and establish a data transmission channel, a communication link, and the like between the computer device 10000 and the external terminal. The network may be a wireless or wired network, for example, an Intranet, the Internet, a global system for mobile communications (GSM), a wideband code division a plurality of access (WCDMA), a 4G network, a 5G network, Bluetooth, or Wi-Fi.

It should be noted that FIG. 8 shows only a computer device with the components 10010 to 10030. However, it should be understood that implementation of all the shown components is not required, and more or fewer components may alternatively be implemented.

In the embodiment, the rate-distortion optimized quantization method stored in the memory 10010 may be further divided into one or more program module to be executed by one or more processors (the processor 10020 in the embodiment), to complete the embodiment of the application.

### Embodiment 4

The application further provides a computer-readable storage medium. The computer-readable storage medium stores computer-readable instructions. When the computer-readable instructions are executed by a processor, the steps of the rate-distortion optimized quantization method in Embodiment 1, Embodiment 2, or Embodiment 3.

In the embodiment, the computer-readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the computer-readable storage medium may be an internal storage unit of a computer device, for example, a hard disk or an internal memory of the computer device. In some other embodiments, the computer-readable storage medium may be an external storage device of the computer device, for example, a removable hard disk, a smart media card (SMC), a secure digital (SD) card, or a flash card that is disposed on the computer device. Certainly, the computer-readable storage medium may alternatively include both an internal storage unit of the computer device and an external storage device of the computer device. In the embodiment, the computer-readable storage medium is usually configured to store an operating system and various application software that are installed on the computer device, for example, program code of the rate-distortion optimized quantization method in the embodiments. In addition, the computer-readable storage medium may be further configured to temporarily store various types of data that have been output or are to be output.

Clearly, a person skilled in the art should understand that the foregoing means or steps in the embodiments of the application may be implemented by using a general computing apparatus. The means or steps may be integrated into a single computing apparatus or distributed in a network including a plurality of computing apparatuses. Optionally, the means or steps may be implemented by using program code that can be executed by the computing apparatus. Therefore, the means or steps may be stored in a storage apparatus for execution by the computing apparatus. In addition, in some cases, the shown or described steps may be performed in a sequence different from the sequence herein. Alternatively, the means or steps may be separately made into integrated circuit means, or a plurality of means or steps in the means or steps may be made into a single integrated circuit means for implementation. In this way, a combination of any specific hardware and software is not limited in the embodiments of the application.

It should be noted that the foregoing descriptions are merely preferred embodiments of the application, and are not intended to limit the patent protection scope of the application. Any equivalent structure or equivalent procedure change made based on the content of the specification and the accompanying drawings of the application is directly or indirectly applied to other related technical fields, and shall fall within the patent protection scope of the application.

1. A rate-distortion optimized quantization method, comprising:
determining a plurality of mapping groups in a superblock, wherein each mapping group comprises a context and an initial quantization level, the superblock is a coding block unit in a to-be-coded video frame, the superblock comprises a plurality of elements, and the context is used to represent correlation information between an element associated with a corresponding mapping group and a plurality of adjacent elements;
determining a coded bit quantity difference of each mapping group, wherein the coded bit quantity difference is a difference between a coded bit quantity of the initial quantization level in the corresponding mapping group and a coded bit quantity of the initial quantization level minus one in the corresponding mapping group; and
determining a target quantization level of each element in the superblock based on the coded bit quantity difference of each mapping group.

2. The rate-distortion optimized quantization method according to claim 1, further comprising:
storing a mapping relationship between each mapping group and the corresponding coded bit quantity difference in a bit quantity difference array, wherein the bit quantity difference array comprises a first bit quantity difference array and a second bit quantity difference array, wherein
the first bit quantity difference array corresponds to an initial quantization level lower than a first preset value; and
the second bit quantity difference array corresponds to an initial quantization level between a second preset value and a third preset value.

3. The rate-distortion optimized quantization method according to claim 1, wherein the superblock corresponds to a plurality of transform units; and
the determining a target quantization level of each element in the superblock based on the coded bit quantity difference of each mapping group comprises:
determining a context of each element in a transform unit; and
scanning the transform unit in a preset sequence, and performing following operations when a current element in the transform unit is scanned:
obtaining an initial quantization level and a target context of the current element in response to the initial quantization level of the current element being a non-zero value, wherein the current element is an element in the transform unit;
querying a target mapping group from the mapping group based on the initial quantization level and the target context of the current element; and
determining a target quantization level of the current element based on a target coded bit quantity difference in the target mapping group.

4. The rate-distortion optimized quantization method according to claim 3, further comprising: storing a mapping relationship between a position of each element and a context of each element in a context array; and
the obtaining an initial quantization level and a target context of the current element in response to the initial quantization level of the current element being a non-zero value comprises: querying the target context from the context array based on a position of the current element.

5. The rate-distortion optimized quantization method according to claim 3, wherein the determining a target quantization level of the current element based on a target coded bit quantity difference in the target mapping group comprises:
determining the initial quantization level of the current element as the target quantization level of the current element in response to the target coded bit quantity difference being not greater than a reference threshold; and
determining the initial quantization level minus one of the current element as the target quantization level of the current element in response to the target coded bit quantity difference being greater than the reference threshold.

6. The rate-distortion optimized quantization method according to claim 5, further comprising: determining the reference threshold by:
determining a first value obtained by dividing a quantization step by λ, wherein λ is a fixed value;
determining a second value obtained by subtracting one from a product of doubling the initial quantization level of the current element;
determining a third value obtained by multiplying the second value by the quantization step;
determining a fourth value obtained by subtracting a product of doubling a transform coefficient of the current element from the third value; and
determining a fifth value obtained by multiplying the first value by the fourth value, and determining a negative number of the fifth value as the reference threshold.

7. The rate-distortion optimized quantization method according to claim 3, further comprising:
skipping the current element in response to the initial quantization level of the current element being zero, and scanning a next element of the current element.

8. The rate-distortion optimized quantization method according to claim 1, wherein
the coded bit quantity of the initial quantization level in the corresponding mapping group is obtained based on the context and the initial quantization level in the corresponding mapping group; and
the coded bit quantity of the initial quantization level minus one in the corresponding mapping group is obtained based on the context and the initial quantization level minus one in the corresponding mapping group.

9. (canceled)

10. A computer device, comprising a memory, a processor, and computer-readable instructions that are stored in the memory and that are capable of running on the processor, wherein when executing the computer-readable instructions, the processor is configured to implement the following steps:
determining a plurality of mapping groups in a superblock, wherein each mapping group comprises a context and an initial quantization level, the superblock is a coding block unit in a to-be-coded video frame, the superblock comprises a plurality of elements, and the context is used to represent correlation information between an element associated with corresponding mapping group and a plurality of adjacent elements;
determining a coded bit quantity difference of each mapping group, wherein the coded bit quantity difference is a difference between a coded bit quantity of the initial quantization level in the corresponding mapping group and a coded bit quantity of the initial quantization level minus one in the corresponding mapping group; and
determining a target quantization level of each element in the superblock based on the coded bit quantity difference of each mapping group.

11. The computer device according to claim 10, wherein when executing the computer-readable instructions, the processor is further configured to implement the following step:
storing a mapping relationship between each mapping group and the corresponding coded bit quantity difference in a bit quantity difference array, wherein the bit quantity difference array comprises a first bit quantity difference array and a second bit quantity difference array, wherein
the first bit quantity difference array corresponds to an initial quantization level lower than a first preset value; and
the second bit quantity difference array corresponds to an initial quantization level between a second preset value and a third preset value.

12. The computer device according to claim 10, wherein the superblock corresponds to a plurality of transform units; and
the determining a target quantization level of each element in the superblock based on the coded bit quantity difference of each mapping group comprises:
determining a context of each element in a transform unit; and
scanning the transform unit in a preset sequence, and performing the following operations when a current element in the transform unit is scanned:
obtaining an initial quantization level and a target context of the current element in response to the initial quantization level of the current element being a non-zero value, wherein the current element is an element in the transform unit;
querying a target mapping group from the mapping group based on the initial quantization level and the target context of the current element; and
determining a target quantization level of the current element based on a target coded bit quantity difference in the target mapping group.

13. The computer device according to claim 12, wherein when executing the computer-readable instructions, the processor is further configured to implement the following step: storing a mapping relationship between a position of each element and a context of each element in a context array; and
the obtaining an initial quantization level and a target context of the current element in response to the initial quantization level of the current element being a non-zero value comprises: querying the target context from the context array based on a position of the current element.

14. The computer device according to claim 12, wherein the determining a target quantization level of the current element based on a target coded bit quantity difference in the target mapping group comprises:
determining the initial quantization level of the current element as the target quantization level of the current element in response to the target coded bit quantity difference being not greater than a reference threshold; and
determining the initial quantization level minus one of the current element as the target quantization level of the current element in response to the target coded bit quantity difference being greater than the reference threshold.

15. The computer device according to claim 14, wherein when executing the computer-readable instructions, the processor is further configured to determine the reference threshold by:
determining a first value obtained by dividing a quantization step by λ, wherein λ is a fixed value;
determining a second value obtained by subtracting one from a product of doubling the initial quantization level of the current element;
determining a third value obtained by multiplying the second value by the quantization step;
determining a fourth value obtained by subtracting a product of doubling a transform coefficient of the current element from the third value; and
determining a fifth value obtained by multiplying the first value by the fourth value, and determining a negative number of the fifth value as the reference threshold.

16. The computer device according to claim 12, wherein when executing the computer-readable instructions, the processor is further configured to implement the following step:
skipping the current element in response to the initial quantization level of the current element being zero, and scanning a next element of the current element.

17. The computer device according to claim 10, wherein
the coded bit quantity of the initial quantization level in the corresponding mapping group is obtained based on the context and the initial quantization level in the corresponding mapping group; and
the coded bit quantity of the initial quantization level minus one in the corresponding mapping group is obtained based on the context and the initial quantization level minus one in the corresponding mapping group.

18. A non-transitory computer-readable storage medium, storing computer-readable instructions, wherein the computer-readable instructions are capable of being executed by at least one processor to enable the at least one processor to perform the following steps:
determining a plurality of mapping groups in a superblock, wherein each mapping group comprises a context and an initial quantization level, the superblock is a coding block unit in a to-be-coded video frame, the superblock comprises a plurality of elements, and the context is used to represent correlation information between an element associated with a corresponding mapping group and a plurality of adjacent elements;
determining a coded bit quantity difference of each mapping group, wherein the coded bit quantity difference is a difference between a coded bit quantity of the initial quantization level in the corresponding mapping group and a coded bit quantity of the initial quantization level minus one in the corresponding mapping group; and
determining a target quantization level of each element in the superblock based on the coded bit quantity difference of each mapping group.

19. The non-transitory computer-readable storage medium according to claim 18, wherein the at least one processor is further enabled to perform the following steps:
storing a mapping relationship between each mapping group and the corresponding coded bit quantity difference in a bit quantity difference array, wherein the bit quantity difference array comprises a first bit quantity difference array and a second bit quantity difference array, wherein
the first bit quantity difference array corresponds to an initial quantization level lower than a first preset value; and
the second bit quantity difference array corresponds to an initial quantization level between a second preset value and a third preset value.

20. The non-transitory computer-readable storage medium according to claim 18, wherein the superblock corresponds to a plurality of transform units; and
the determining a target quantization level of each element in the superblock based on the coded bit quantity difference of each mapping group comprises:
determining a context of each element in a transform unit; and
scanning the transform unit in a preset sequence, and performing the following operations when a current element in the transform unit is scanned:
obtaining an initial quantization level and a target context of the current element in response to the initial quantization level of the current element being a non-zero value, wherein the current element is an element in the transform unit;
querying a target mapping group from the mapping group based on the initial quantization level and the target context of the current element; and
determining a target quantization level of the current element based on a target coded bit quantity difference in the target mapping group.
